(19) United States
(12) Patent Application Publication
(10) Pub. No.: US 2025/0314515 A1
(43) Pub. Date: Oct. 9, 2025

(54) CONTAINER WITH FORCE SENSOR, SUBSTANCE MEASURING SYSTEM WITH FORCE SENSOR AND SUBSTANCE PROVIDING SYSTEM WITH FORCE SENSOR

(71) Applicant: PixArt Imaging Inc., Hsin-Chu City (TW)

(72) Inventors: Sen-Huang Huang, Hsin-Chu City (TW); Ming Shun Manson Fei, Hsin-Chu City (TW)

(73) Assignee: PixArt Imaging Inc., Hsin-Chu City (TW)

(21) Appl. No.: 19/087,578

(22) Filed: Mar. 23, 2025

Related U.S. Application Data
(60) Provisional application No. 63/575,842, filed on Apr. 7, 2024.

(51) Int. Cl. G01F 23/20; G01F 23/292

(52) U.S. Cl. CPC G01F 23/205; G01F 23/292

(57) ABSTRACT

A container, comprising: a bottom surface; at least one side surface, surrounding the bottom surface to form a closed shape; and at least one force sensor, located on the side surface, configured to sense at least one force provided by substance in a space formed by the bottom surface and the side surface. A substance measuring system using the container is also disclosed. A substance providing system is also disclosed. By this way, force sensors can be provided in suitable locations corresponding to different requirements, to assist measuring the amount of substance or assist other operations requires substance allocating.

### CROSS REFERENCE TO RELATED APPLICATIONS

This application claims the benefit of U.S. Provisional Application No. 63/575, 842, filed on Apr. 7, 2024. The content of the application is incorporated herein by reference.

### BACKGROUND OF THE INVENTION

### 1. Field of the Invention

The present invention relates to a container, a substance measuring system and a substance providing system, and particularly relates to a container with at least one force sensor, a substance measuring system with at least one force sensor and a substance providing system with at least one force sensor.

### 2. Description of the Prior Art

In modern life, some devices that can measure the height or amount of substances are used, such as devices to measure the height of water or devices to measure the amount of ice cubes. However, these devices generally utilize visual methods, or utilize less precise methods. For example, a refrigerator usually has an ice maker, and the ice cubes produced by the ice maker automatically fall into an ice storage box. When the amount of ice cubes in the ice storage box reaches a predetermined level, the ice maker stops producing ice cubes. A conventional ice maker detects the amount of ice cubes mechanically. For example, when the height of the ice cubes stacked in the ice storage box is high, the ice cubes will contact a mechanical rod above the ice storage box, thereby causing the mechanical rod to move to control the ice maker to stop producing ice cubes. However, since the ice cubes are not evenly distributed in the ice box, in some cases, the overall amount of ice cubes may still be small but only stack high in the area under the mechanical rod, which may still cause the ice maker to stop working.

Therefore, a more accurate measurement method is needed.

### SUMMARY OF THE INVENTION

One objective of present invention is to provide a container with at least one force sensor.

Another objective of present invention is to provide a substance measuring system with at least one force sensor.

Still another objective of present invention is to provide a substance providing system with at least one force sensor.

One embodiment of the present invention discloses a container, comprising: a bottom surface; at least one side surface, surrounding the bottom surface to form a closed shape; and at least one force sensor, located on the side surface, configured to sense at least one force provided by substance in a space formed by the bottom surface and the side surface.

Another embodiment of the present invention discloses a substance measuring system comprising a processing circuit and a container. The container comprises: a bottom surface; at least one side surface, surrounding the bottom surface to form a closed shape; and at least one force sensor, located on the side surface, configured to sense at least one force provided by first substance in a space formed by the bottom surface and the side surface; wherein the processing circuit determines a height or an amount of the first substance in the space according to the force sensed by the force sensor.

Still another embodiment of the present invention discloses a substance providing system, comprising: a substance providing device; at least one force sensor, configured to sense at least one force provided by a bottom surface of a container; and a processing circuit, configured to determine a shape of the bottom surface according to the force, and configured to control a substance providing device to provide substance into the container according to the shape.

In view of above-mentioned embodiments, force sensors can be provided in suitable locations corresponding to different requirements, to assist measuring the amount of substance or assist other operations requires substance allocating.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a container according to one embodiment of the present invention.

FIG. 2 is a schematic diagram illustrating a container according to another embodiment of the present invention.

FIG. 3A and FIG. 3B are schematic diagrams illustrating ice storage boxes according to embodiments of the present invention.

FIG. 4 is a schematic diagram illustrating an ice storage box according to another embodiment of the present invention.

FIG. 5 and FIG. 6 are schematic diagrams illustrating a substance measuring system according to one embodiment of the present invention.

FIG. 7 is a schematic diagram illustrating substance measuring systems according to embodiments of the present invention.

FIG. 8 and FIG. 9 are schematic diagrams illustrating substance providing systems according to embodiments of the present invention.

### DETAILED DESCRIPTION

In the following descriptions, several embodiments are provided to explain the concept of the present application. The terms “first”, “second”, “third” in following descriptions are only for the purpose of distinguishing different one elements, and do not mean the sequence of the elements. For example, a first device and a second device only mean these devices can have the same structure but are different devices.

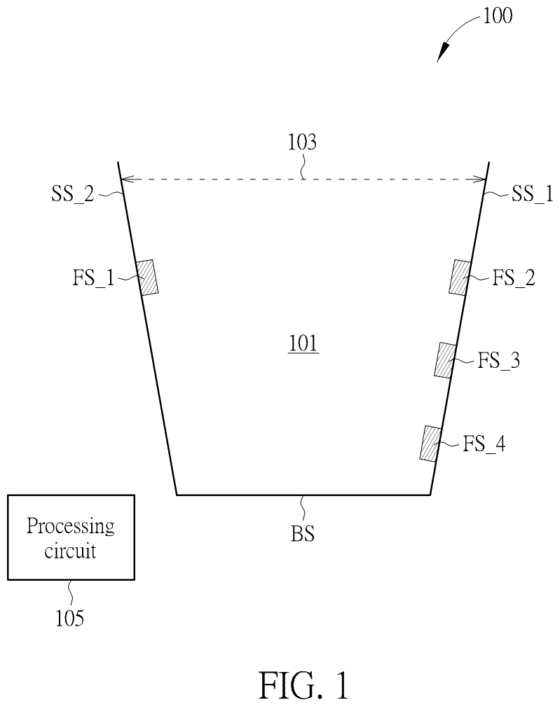

FIG. 1 is a schematic diagram illustrating a container 100 according to one embodiment of the present invention. As shown in FIG. 1, the container 100 (e.q., a cup or a box) comprises a bottom surface BS, at least one side surface and at least one force sensor. The side surface is surrounding the bottom surface BS to form a closed shape. For example, if the container 100 is a square container, the side surface forms a closed square. For another example, if the container 100 is a cylindrical container, the side surface forms a closed circle.

In the embodiment of FIG. 1, the container 100 comprises a side surface SS_1 and a side surface SS_2. The side surface SS_1 and the side surface SS_2 may be different side surfaces. For example, if the container 100 is a square container, the side surface SS_1 and the side surface SS_2 are different side surfaces. However, the side surface SS_1 and the side surface SS_2 may be different portions of the same side surface. For example, if the container 100 is a cylindrical container, the side surface SS_1 and the side surface SS_2 are different portions of the same side surface.

The force sensor is located on (attached to) the side surface. For example, in FIG. 1, a force sensor FS_1 is located on the side surface SS_2, and three force sensors FS_2, FS_3 and FS_4 are provided on the side surface SS_1. The force sensor is configured to sense at least one force provided by substance in the space formed by the bottom surface and the side surface. For example, the space 101 is formed by the bottom surface BS and the side surfaces of the container 100. The force sensors FS_1, FS_2, FS_3 and FS_4 can sense lateral forces provided by liquid such as water, if the liquid in the space 101 covers the force sensors FS_1, FS_2, FS_3 and FS_4. The liquid can be replaced by colloid such as jelly or solid such as granulated sugar.

The force sensors can be arranged corresponding different requirements. In the embodiment of FIG. 1, the side surfaces of the container 100 form an opening opposite to the bottom surface BS. For example, the side surfaces comprising the side surfaces SS_1, SS_2 form an opening 103 opposite to the bottom surface BS. In such embodiment, the force sensors may be arranged from the opening 103 to the bottom surface BS. In such case, the force sensor is far from the bottom surface. Alternatively, the force sensors may be arranged from the bottom surface BS to the opening 103, such as the force sensors FS_2, FS_3, FS_4. In such case, the force sensors can be regarded as arranged from the bottom surface BS to a direction away from the bottom surface BS. By this way, the force sensors are close to the bottom surface BS, thus the substance can still cover the force sensor even if only little substance is in the container 100.

In one embodiment, a processing circuit 105 is provided to determine a height or an amount of the substance in the space 101 according to the force sensed by the force sensor. In such case, the system comprising the container 100 and the processing circuit 105 can be regarded as a substance measuring system.

For example, if only the force sensor FS_4 senses a larger force and other force sensors do not sense forces or only sense a small force, the processing circuit 105 determines a height of the substance is low or an amount of the substance is less. On the contrary, if all force sensors FS_1 . . . FS_4 sense a larger force, the processing circuit 105 determines a height of the substance is high or an amount of the substance is much.

In another embodiment, the processing circuit 105 may determine the height level or the amount level of the substance according to which force sensor senses a larger force. For example, if only the force sensor FS_4 senses a larger force and other force sensors do not sense forces or only sense a small force, the processing circuit 105 determines a height of the substance is a height level 1 or an amount of the substance is an amount level 1. For another example, if the force sensor FS_4, FS_3 sense larger forces and other force sensors do not sense forces or only sense a small force, the processing circuit 105 determines a height of the substance is a height level 2 or an amount of the substance is an amount level 2. It will be appreciated that the descriptions of FIG. 1 are only for example, any variation based on the above-mentioned disclosure should also fall in the scope of the present application.

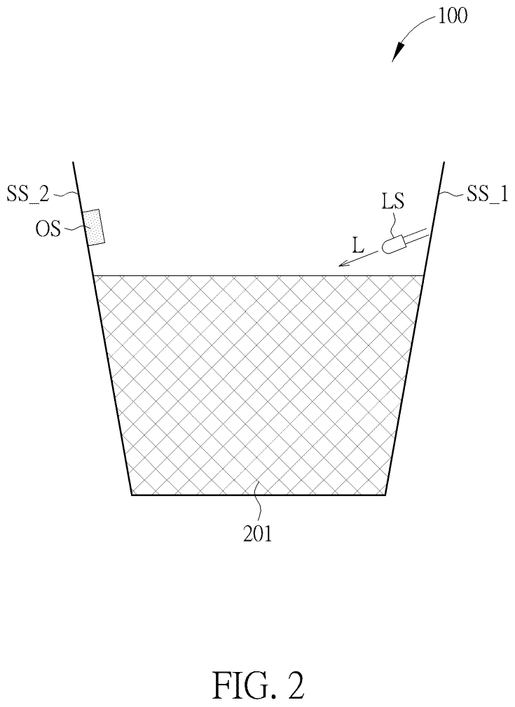

Other devices can be provided in the container 100 to assist the detection of substance. FIG. 2 is a schematic diagram illustrating a container 100 according to another embodiment of the present invention. In the embodiment of FIG. 2, at least one optical sensor is provided on the side surface. For example, an optical sensor OS is provided on the side surface SS_2 and is in the space 101. Please note, the container 100 in FIG. 2 may have the same components of the container 100 in FIG. 1, besides the optical sensor OS and the light source LS. However, for the convenience of explaining, some components in FIG. 1 are not illustrated or symbolized in FIG. 2. Please note, in some of the following embodiments, the optical sensor is provided in the space. However, the optical sensor may also be provided outside the space if the optical sensor can detect the inside condition of the container. For example, if the container is made of transparent material, the optical sensor may be provided outside the space.

The optical sensor OS is configured to detect optical data such as images, and the height of the substance 201 in FIG. 2 can be determined by the processing circuit 105 according to the optical data. For example, in FIG. 2, the light source LS emits light L to the substance 201 and causes different light patterns responding to different heights of the substance 201. Also, if the liquid height is high thus blocks the light source LS, the light pattern also changes. Accordingly, the height of the substance 201 may be determined by the processing circuit 105 according to the light pattern sensed by the optical sensor OS.

As above-mentioned the container 100 and the processing circuit 105 can be regarded as a substance measuring system. Besides measuring the amount or the height of the substance, the substance measuring system may further control a substance providing device to provide substance to the container 100 according to the amount or the height. For example, if the amount is low, the provide substance can provide substance to the container 100 until the amount reaches a predetermined level. In one embodiment, the substance measuring system further provides second substance to the space according to the height of the first substance. For example, if the height of coffee reaches a predetermined height, the substance measuring system stops providing the coffee and then provides milk to the substance measuring system until the liquid in the container 100 reaches another predetermined total height. By this way, the ingredients needed for a specific drink can be automatically provided.

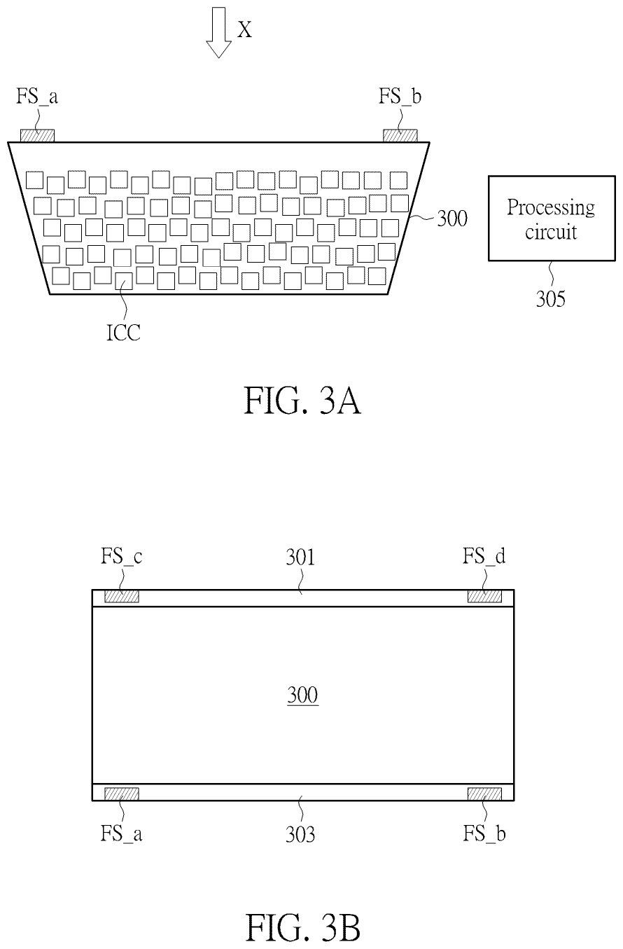

The concepts of force sensors may be applied to other applications. FIG. 3A and FIG. 3B are schematic diagrams illustrating ice storage boxes according to embodiments of the present invention. FIG. 3B is a top view of FIG. 3A, in other words, FIG. 3B is a drawing of FIG. 3A viewed from the X direction. As shown in FIG. 3A and FIG. 3B, force sensors FS_a, FS_b, FS_c and FS_d are provided below slide rails 301 of the ice storage box 300. In such case, the ice storage box 300 is suspended such that weight of the ice cubes ICC in the ice storage box 300 can cause forces which can be sensed by the force sensors FS_a, FS_b, FS_c and FS_d. However, the locations of the force sensors FS_a, FS_b, FS_c and FS_d can be change corresponding to the location or the structure of the ice storage box 300 in the refrigerator.

In the embodiment of FIG. 3A, a processing circuit 305 is provided to control the ice maker which produces the ice cubes ICC. The force sensed by the force sensors FS_a, FS_b, FS_c and FS_d is transmitted to the processing circuit 305. If the sensed force is above a force threshold, it may mean the ice storage box 300 contains a large amount of ice cubes ICC. Accordingly, the processing circuit 305 controls the ice maker to stop generating the ice cubes ICC. By this way, the ice maker can be prevented from making too much ice.

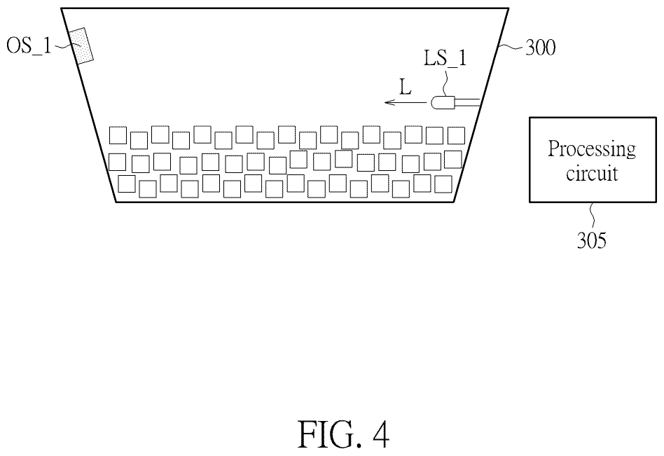

Other devices can be provided in the container 100 to assist the detection of substance. FIG. 4 is a schematic diagram illustrating an ice storage box according to another embodiment of the present invention. In the embodiment of FIG. 4, at least one optical sensor is provided in the ice storage box 300. For example, an optical sensor OS_1 is provided in the ice storage box 300. Please note, the ice storage box 300 in FIG. 4 may have the same components of the ice storage box 300 in FIG. 3A, besides the optical sensor OS_1 and the light source LS_1. However, for the convenience of explaining, some components in FIG. 3A are not illustrated or symbolized in FIG. 4.

The optical sensor OS_1 is configured to detect optical data such as images, and the amount of the ice cubes ICC in FIG. 4 can be determined by the processing circuit 305 according to the optical data. For example, in FIG. 4, the light source LS_1 emits light L. Accordingly, if the height of the ice cubes ICC is high thus blocks the light L, the optical sensor OS_1 cannot sense the light L. Therefore, the amount of the ice cubes ICC can be determined according to the optical data sensed by the optical sensor OS_1. In one embodiment, a plurality of light sources are provided and distributed evenly in the ice storage box 300. In such case, the amount of the ice cubes ICC is determined to be much only when a plurality of light sources are blocked.

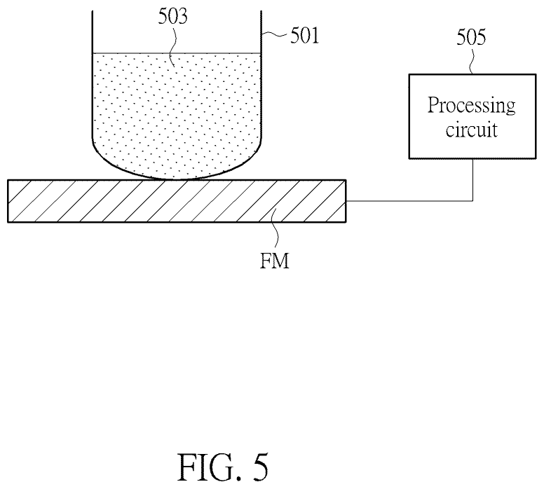

The above-mentioned substance system may have other structures. FIG. 5 is a schematic diagram illustrating a substance measuring system according to one embodiment of the present invention. In above-mentioned embodiments, the force sensors are respectively provided in or on the container. In the embodiment of FIG. 5, a force sensor matrix FM which comprises a plurality of force sensors is provided. The force sensor matrix FM has a larger size thus a container 501 such as a cup can be put on the force sensor matrix FM. In such case, the weight of the substance 503 in the container 501 can cause force to the force sensor matrix FM. If the amount of the substance 503 is much, the force sensor matrix FM senses a larger force. On the opposite, if the amount of the substance 503 is few or zero, the force sensor matrix FM sense a small force or only the force provided by the empty container 501. Accordingly, a processing circuit 505 can be provided to determine an amount of the substance 503 according to the force sensed by force sensor matrix FM. The force sensor matrix FM and the processing circuit 505 can also be regarded as a substance measuring system.

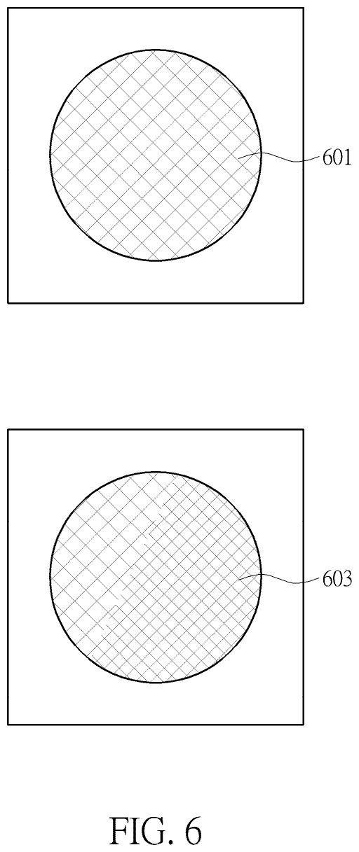

The force sensor matrix FM can sense not only the magnitude of the force but also the distribution of the force, so the sensed force can also be used to determine whether the container is placed stably (i.e., it tilted or not). FIG. 6 illustrates the distribution of the force provided by the container 501. In FIG. 6, in the force distribution pattern, denser oblique lines represent a greater force, and sparser oblique lines represent a smaller force. In the upper diagram of FIG. 6, the container 501 is stably placed on the force sensor matrix FM, so the density of the oblique lines of the force distribution diagram 601 is relatively uniform. In the lower diagram of FIG. 6, the container 501 is tilted to the right on the force sensor matrix FM, so the density of the oblique lines on the right side of the force distribution diagram 603 is larger and the density on the left side is smaller. In this case, a notification message may be sent to inform the user that the container 501 may tip over.

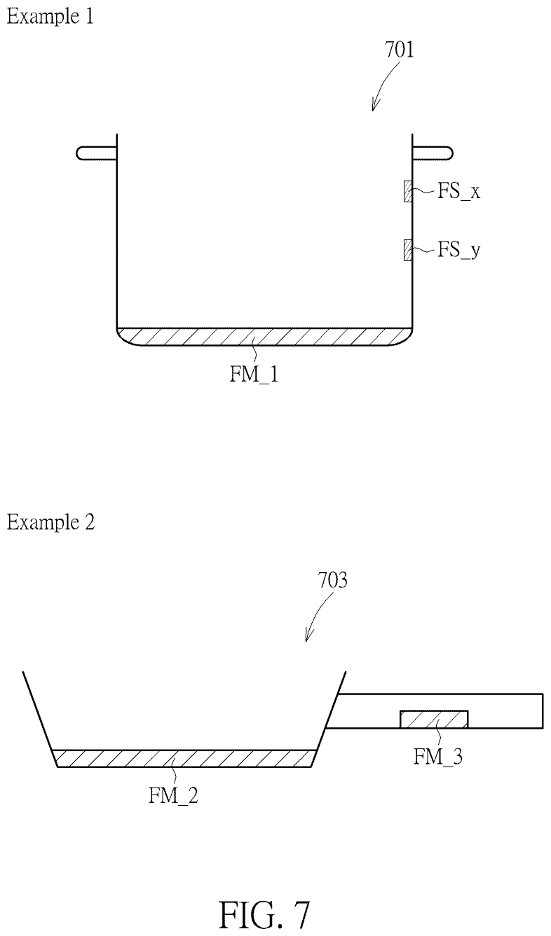

The force sensor matrix can be provided to any other location rather than limited to be outside and below the container. FIG. 7 is a schematic diagram illustrating a substance measuring system according to embodiments of the present invention. In the Example 1 of FIG. 7, the force sensor matrix FM_1 is provided in the bottom of a pot 701, or the force sensors FS_x, FS_y can also be provided on a side surface of the pot 701.

In this case, when the pot 701 is used to cook food, an AI (artificial intelligence) model can be used to assist in cooking. For example, when stewing food, the soup may reduce slowly over time. In such case, the amount or the height of the soup in the pot 701 can be detected by the force sensor matrix FM_1 or the force sensors FS_x, FS_y, and the AI model can add water or other materials appropriately according to the height or the amount of the soup.

In the Example 2 of FIG. 7, the force sensor matrix FM_2 is located on the bottom of the pan 703 and the force sensor matrix FM_3 is located in or on the handle thereof. The force sensor matrices FM_2 and FM_3 can be used to detect the weight of the food in the pan 703. Furthermore, the sensor matrix FM_2 may be used to sense whether the food such as a steal in the pan is placed flatly, otherwise it cannot be heated evenly.

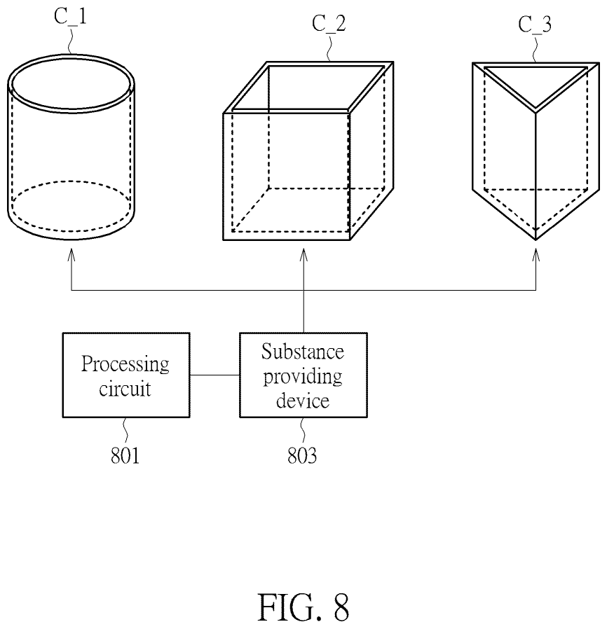

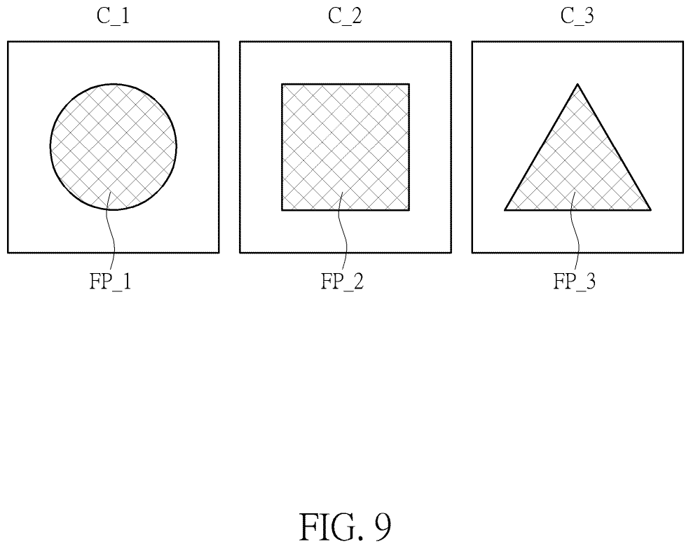

As above-mentioned, the force sensor matrix FM can sense not only the magnitude of the force but also the distribution of the force. Accordingly, the force sensor matrix FM can be used to determine a bottom shape of the container. FIG. 8 and FIG. 9 are schematic diagrams illustrating substance providing systems according to embodiments of the present invention. In FIG. 8, three containers C_1, C_2 and C_3 are provided. In FIG. 9, three force distribution patterns FP_1, FP_2 and FP_3 which respectively correspond to the containers C_1, C_2 and C_3 are shown. The force distribution patterns FP_1, FP_2 and FP_3 represent force provided by the bottom shapes of the containers C_1, C_2 and C_3. Please note, in the embodiment of FIG. 9, the shapes of the containers C_1, C_2 and C_3 correspond to bottom shapes thereof. Specifically, the container C_1 is a cylindrical container and its bottom shape is circular. The container C2 is a regular cube container and its bottom shape is a square. The container C3 is a triangular prism container and its bottom shape is a triangle. However, the shapes of the containers C_1, C_2 and C_3 and bottom surfaces thereof may be different. For example, containers C_1, C_2 and C_3 are all cylindrical container but bottom surface thereof are respectively circular, square and triangle.

In the embodiments of FIG. 8 and FIG. 9, a processing circuit 801 and a substance providing device 803 are provided. The processing circuit 801, the substance providing device 803, and the force sensor matrix (or the force sensor) can be regarded as a substance providing system. As above-mentioned, the force sensor matrix can be used to detect forces caused by a bottom surface of the container. Also, the processing circuit 801 is configured to control a substance providing device 803 to provide substance into the container according to the shape of the bottom surface. Specifically, the processing circuit 801 controls the substance providing device 803 to provide first substance to the container if the shape is a first shape, and controls the substance providing device 803 to provide second substance to the container if the shape is a second shape. For example, the substance providing device 803 provides milk to the container C_1 with a circular surface and provided black tea to the container C_2 with a square bottom surface.

The substance providing system mentioned in FIG. 8 and FIG. 9 can be used for cooking. For example, a user takes turns placing containers C_1, C_2, and C_3 onto the force sensing matrix, and the substance providing device 803 correspondingly provides salt, vinegar, and sour oil to the containers C_1, C_2 and C_3. By this way, while cooking, the user can quickly obtain the correct amount of ingredients or seasonings without step-by-step confirmation. The substance providing system can be used in any other place requires substance allocating, such as a factory or a lab.

In view of above-mentioned embodiments, force sensors can be provided in suitable locations corresponding to different requirements, to assist measuring the amount of substance or assist other operations requires substance allocating.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A container, comprising:
a bottom surface;
at least one side surface, surrounding the bottom surface to form a closed shape; and
at least one force sensor, located on the side surface, configured to sense at least one force provided by substance in a space formed by the bottom surface and the side surface.

2. The container of claim 1,
wherein the side surface form an opening opposite to the bottom surface;
wherein a number of the force sensor is at least two;
wherein the force sensor is arranged from the opening to the bottom surface, or from the bottom surface to the opening.

3. The container of claim 1,
wherein a number of the force sensor is at least two;
wherein the force sensors are arranged from the bottom surface to a direction away from the bottom surface.

4. The container of claim 1, further comprising at least one optical sensor provided on the side surface and in or outside the space.

5. A substance measuring system, comprising:
a processing circuit; and
a container, comprising:
a bottom surface;
at least one side surface, surrounding the bottom surface to form a closed shape; and
at least one force sensor, located on the side surface, configured to sense at least one force provided by first substance in a space formed by the bottom surface and the side surface;
wherein the processing circuit determines a height or an amount of the first substance in the space according to the force sensed by the force sensor.

6. The substance measuring system of claim 5,
wherein the side surface form an opening opposite to the bottom surface;
wherein a number of the force sensor is at least two;
wherein the force sensor is arranged from the opening to the bottom surface, or from the bottom surface to the opening.

7. The substance measuring system of claim 5,
wherein a number of the force sensor is at least two;
wherein the sensors are arranged from the bottom surface to a direction away from the bottom surface.

8. The substance measuring system of claim 5, further comprising at least one optical sensor provided on the side surface and in or outside the space, wherein the processing circuit further determines the height according to optical data sensed by the optical sensor.

9. The substance measuring system of claim 5, wherein the substance measuring system further provides second substance to the space according to the height.

10. A substance providing system, comprising:
a substance providing device;
at least one force sensor, configured to sense at least one force provided by a bottom surface of a container; and
a processing circuit, configured to determine a shape of the bottom surface according to the force, and configured to control a substance providing device to provide substance into the container according to the shape.

11. The substance providing system of claim 10, wherein the processing circuit controls the substance providing device to provide first substance to the container if the shape is a first shape, and controls the substance providing device to provide second substance to the container if the shape is a second shape.

12. The substance providing system of claim 10, wherein the processing circuit further determines whether the container is tilted or not according to the force.
